(19) United States
(12) Patent Application Publication
(10) Pub. No.: US 2026/0111858 A1
(43) Pub. Date: Apr. 23, 2026

(54) NETWORKED COMPUTER SYSTEM FOR ENHANCING HUMAN INTERACTIONS

(71) Applicant: WHAT'S POPP'N LLC, Montgomery, IL (US)

(72) Inventors: Matthew Zeiger, Montgomery, IL (US); Kurtis Zeiger, Montgomery, IL (US)

(73) Assignee: WHAT'S POPP'N LLC, Montgomery, IL (US)

(21) Appl. No.: 19/384,937

(22) Filed: Nov. 10, 2025

Related U.S. Application Data
(60) Provisional application No. 63/693,150, filed on Sep. 10, 2024.

(51) Int. Cl. G06Q 10/40; G06Q 20/32; H04W 4/021

(52) U.S. Cl. CPC G06Q 10/40; G06Q 20/3224; H04W 4/021

(57) ABSTRACT

A computer-implemented system facilitates controlled social interactions in public venues without exposing users outside those venues. A server receives location signals from user devices, confirms presence within a venue geofence using stored boundary data and short-range checks, and issues venue-bound session tokens. The server computes a venue “vibe” profile by fusing audio features, occupancy estimates, and explicit user feedback, and returns the profile to devices. Messaging between devices is authorized only while both present valid tokens; authorization is revoked and venue-scoped identifiers and message metadata are purged when a device leaves or a token expires. Optional features include Live-Peak time-gated live view with credit-based extensions, administrative boundary refinement, and tokenized payments to venue merchants upon acceptance of offers. The system supports interactions beyond dating, including friendship, group coordination, and professional networking.

### CROSS REFERENCE TO RELATED APPLICATIONS

This application claims the benefit of U.S. Provisional Patent Application No. 63/693,150, filed Sep. 10, 2024, entitled “NETWORKED COMPUTER SYSTEM FOR ENHANCING HUMAN INTERACTIONS,” the entire disclosure of which is hereby incorporated by reference herein.

### FIELD OF THE INVENTION

The present disclosure relates generally to networked computer systems for enhancing human interactions, and more particularly, to a networked computer system for enhancing human interactions comprising security features, a payment platform, and improving human interactions by handling rejections with dignity and building relationships with privacy, particularly in public spaces.

### BACKGROUND

Current social networking and dating systems do not confine visibility and communication to verified real-world presence, allowing unsolicited or lingering contacts and creating privacy risks. Existing location-based systems merely show nearby users without strong presence verification or automatic severance of contacts.

There is a need for a networked computer system that (i) verifies real-world presence using geofencing and short-range proofs, (ii) issues venue-scoped ephemeral identifiers and tokens, (iii) confines and automatically terminates visibility and interaction to the period of verified presence, and (iv) enforces venue-scoped payment tokens usable only while present.

Human interaction plays a vital role in the social fabric of society, fostering connections that enhance well-being, self-esteem, and overall societal harmony. However, certain types of interactions, particularly those involving rejection in public spaces, can have detrimental effects on both the individuals involved and society as a whole.

Studies have shown that rejection, especially when it occurs in public settings, can lead to significant psychological harm. For the person who is rejected, the experience often results in feelings of embarrassment, shame, and reduced self-esteem. Research published in *Psychological Science* has highlighted that social rejection activates the same neural pathways in the brain as physical pain, indicating the profound emotional impact it can have.

Moreover, public rejection can exacerbate these negative feelings, as the presence of witnesses often intensifies the sense of humiliation. This can lead to long-term psychological consequences, including anxiety, depression, and social withdrawal. The American Psychological Association (APA) notes that such experiences of rejection can contribute to a cycle of negative self-perception and decreased social engagement, ultimately harming the individual's ability to form healthy relationships in the future.

The impact of public rejection extends beyond the individual, affecting society as a whole. When rejection becomes a common aspect of public interactions, it fosters an environment of hostility and social division. This can erode trust and cooperation among members of the community, leading to increased social isolation and a breakdown in communal ties.

Furthermore, societal norms that tolerate or even encourage public rejection can contribute to a culture of exclusion. This culture can marginalize vulnerable groups, perpetuate inequalities, and undermine efforts to create inclusive and supportive social environments. Research from the *Journal of Personality and Social Psychology* has demonstrated that societies with higher levels of social exclusion tend to experience greater levels of conflict, decreased social cohesion, and lower overall well-being.

The act of rejecting another person, particularly in a public space, not only harms the individual who is rejected but also has broader implications for society. By degrading the quality of human interactions, public rejection diminishes self-esteem, promotes social division, and contributes to a culture of exclusion, all of which undermine the social fabric necessary for a healthy and thriving community.

Further, personal relationships are increasingly subjected to public scrutiny, particularly in the digital age where social interactions are often shared and observed in real-time. Building a personal relationship in the public eye, especially within public spaces, presents unique challenges and can have negative impacts on the individuals involved and the relationship itself.

Privacy is a fundamental aspect of developing close personal relationships. According to research published in the *Journal of Social and Personal Relationships*, privacy allows individuals to manage the flow of information and control the pace and depth of relational development. When privacy is compromised, it can lead to stress, anxiety, and a breakdown in communication between the parties involved.

One of the primary issues with building a relationship in public is the lack of control over external influences. In public spaces, interactions are often subject to observation and commentary by bystanders, which can create pressure and discomfort. A study in *Cyberpsychology, Behavior, and Social Networking* found that the presence of an audience during personal interactions can lead to increased self-consciousness and a tendency to alter behavior, which may hinder the authenticity of the relationship.

Moreover, the intrusion of public opinion can disrupt the natural progression of the relationship. Research from the *Journal of Communication* indicates that relationships exposed to public scrutiny are more susceptible to external judgments, which can cause partners to feel obligated to conform to societal expectations rather than following their own relational norms. This pressure can stifle the emotional connection between individuals, leading to dissatisfaction and conflict.

The constant visibility in public spaces also impairs the ability to resolve conflicts privately. Disagreements that occur in public often become performative, with individuals feeling the need to defend their reputation rather than address the underlying issues in the relationship. This phenomenon, highlighted in a study from the *International Journal of Conflict Management*, demonstrates that public exposure during conflicts increases stress and reduces the likelihood of reaching a constructive resolution.

Furthermore, the lack of privacy in public spaces can lead to a sense of vulnerability and exposure. This can discourage individuals from engaging in open and honest communication, which is essential for building trust, intimacy, and a relationship. The American Psychological Association has documented that relationships lacking in trust and open communication are more prone to dissatisfaction and eventual dissolution.

Attempting to build a personal relationship in the public eye, particularly within public spaces, poses significant challenges that can negatively impact the relationship and the individuals involved. The lack of privacy leads to increased stress, external pressures, and difficulties in conflict resolution, all of which undermine the foundation of a healthy and successful relationship.

Ideally, it would be extremely useful to enhance human interactions by allowing such interactions to take place in a private fashion, even when physically in public. Accordingly, there is a need for a solution to at least one of the aforementioned problems. For instance, there is an established need for allowing two people to begin building a relationship while maintaining privacy, even when the building of the relationship begins in a public space.

### SUMMARY

The disclosed technology facilitates controlled social interactions across public venues including nightlife establishments, restaurants, sporting events, gyms, and professional networking settings, and is not limited to dating contexts.

A system of one or more computers can be configured to perform particular operations or actions by virtue of having software, firmware, hardware, or a combination thereof installed on the system that in operation cause the system to perform the actions. One or more computer programs can be configured to perform particular operations or actions by virtue of including instructions that, when executed by data processing apparatus, cause the apparatus to perform the actions.

In one general aspect, a networked computer system includes a processor and memory. The system further includes a display, a user interface, and a communication module configured to connect to a network. The system also includes a server system configured to communicate with a user device over the network. The server system includes a processor and memory storing executable instructions that, when executed by the processor, cause the system to: receive data from multiple public spaces, where the data comprises real-time information about the environment, crowd density, social activities, and general ambiance of the public spaces; analyze the received data using machine learning algorithms to generate a vibe profile for each public space, the vibe profile being a representation of the current social atmosphere and interaction potential of the public space; and transmit the vibe profile to the user device upon request.

The system further includes a public space sensor system located in a public space, such as an event venue, restaurant, bar, or other social gathering place. The sensor system includes environmental sensors configured to monitor and collect data on factors such as noise levels, lighting, and temperature; occupancy sensors configured to detect the number of people present and their distribution within the public space; and social interaction sensors, including cameras and microphones, connected to the networked computer system over the network. The networked computer system for enhancing human interactions, or the server system, is configured to analyze group behaviors, social interactions, and general activity patterns within the space while maintaining privacy by anonymizing individual data. A communication module is configured to transmit the collected data to the server system in real-time.

The system further includes a vibe checking module comprising a user interface that allows the user to select a public space and request the vibe profile generated by the server system. A display is configured to present the vibe profile to the user, including graphical representations of crowd density, social activities, and other relevant information, where the display can be a mobile device, desktop computer, or other device comprising a screen configured to display the vibe profile.

The system also includes an interaction facilitation module accessible by a mobile device, desktop computer, or other device comprising a screen and configured to operate the interaction facilitation module. A user interface allows the user to initiate interaction with other users at the selected public space once physically present, through various communication means such as text messaging, voice chat, or video calls. A proximity-based user discovery feature detects the presence of other users in the same public space and suggests potential interactions based on shared interests or mutual connections. A feedback module allows users to rate their interactions and the overall vibe of the public space, where the feedback is transmitted to the server system to further refine the vibe profiles for future users.

Optionally, the system includes predefined messages comprising a selection of polite and empathetic predefined messages for common interactions, such as accepting and responding to a communication, or declining the communication or ending a conversation. Optionally, the system includes a tone analysis module using natural language processing (NLP) to analyze the tone of messages before they are sent, offering suggestions to aid in ensuring the messages are respectful.

A network communication system enables secure data exchange between the user device, server system, and public space sensor system, where the communication system supports real-time data transmission and user interactions with low latency. Other embodiments of this aspect include corresponding computer systems, apparatus, and computer programs recorded on one or more computer storage devices, each configured to perform the actions of the methods.

While certain embodiments involve dating-related interactions, the invention is not limited to dating. Instead, it provides a generalized social-interaction framework applicable to nightlife venues, restaurants, sporting events, gyms, professional networking spaces, and other public or semi-public locations. Dating is therefore considered only one example of the social interactions supported by the disclosed system.

Implementations may include one or more of the following features:

A networked computer system wherein the server system further comprises a machine learning module configured to continuously learn from user interactions and feedback, thereby dynamically updating the vibe profiles for enhanced accuracy and user satisfaction.

A networked computer system wherein the user device is configured to provide notifications to the user when a preferred vibe profile is detected in a selected public space, based on the user's predefined preferences and past interaction history.

The networked computer system may include a payment processing module configured to allow a first user to pay for goods sold at the public space for a second user, with the payment being sent to the public space for said goods.

An encryption module that employs comprehensive encryption methods to protect user data during transmission and storage.

An authentication module that implements multi-FACTOR authentication to ensure only authorized users access the system.

A data storage module that uses secure coding practices to prevent common vulnerabilities.

A privacy module that ensures rejections are handled privately to avoid public embarrassment.

A compliance module that ensures the system adheres to GDPR, CCPA, and other relevant data protection regulations.

A future feature of a camera system accessible only through the application, to be implemented as the clientele grows.

Implementations of the described techniques may include hardware, a method or process, or a non-transitory computer-readable medium.

### BRIEF DESCRIPTION OF THE DRAWINGS

The preferred embodiments of the disclosure will hereinafter be described in conjunction with the appended drawings provided to illustrate and not to limit the disclosure, where like designations denote like elements, and in which:

FIG. 1 illustrates an exemplary system architecture for implementing geofenced social interactions within venues.

FIG. 2A illustrates a flowchart of operations for issuing venue-bound tokens and authorizing messaging.

FIG. 2B illustrates a flowchart of the Live-Peak feature providing limited venue live-view access.

FIG. 3 presents an exemplary aspect of the computer system as described in the disclosure, according to one or more embodiments.

FIG. 4A-4B present an exemplary flow diagram of an aspect of the disclosure, according to one or more embodiments.

FIG. 5 presents a venue for a user, according to one or more embodiments.

FIG. 6 presents a backend service application programming interface (API), according to one or more embodiments.

FIG. 7 illustrates the structure of a venue-bound session token and associated validation sequence.

FIG. 8 illustrates a machine learning pipeline for computing venue vibe categories.

Like reference numerals refer to like parts throughout the several views of the drawings.

### DETAILED DESCRIPTION

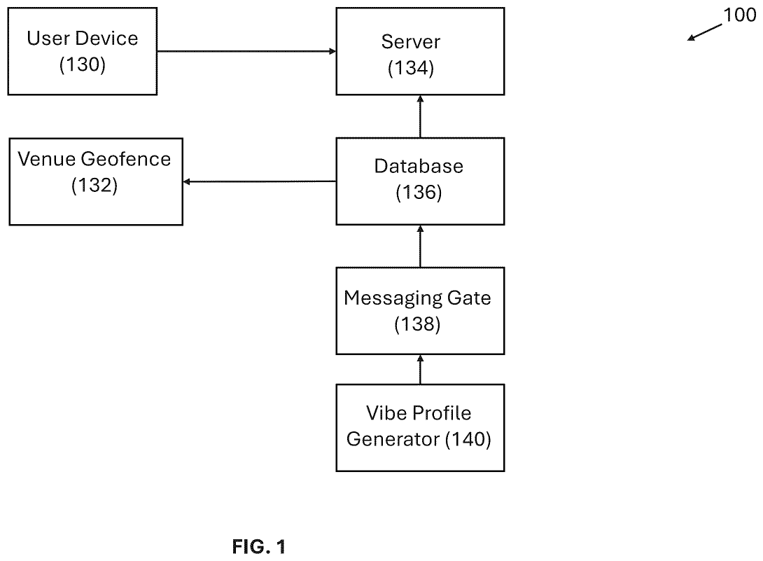

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the disclosure as oriented in FIG. 1. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward a networked computer system for enhancing human interactions.

The present disclosure is directed toward a networked computer system for enhancing human interactions (“computer system”) that facilitates private, dignified, and secure social interactions in public spaces, including handling rejections with dignity and enabling relationship-building while preserving privacy.

The computer system is configured to secure user data during transmission and storage, implement multi-factor authentication to ensure only authorized users access the system, employ secure coding practices to prevent common vulnerabilities, use tokenization and data minimization strategies to protect sensitive user information, and ensure compliance with relevant data protection regulations such as GDPR and CCPA.

In one embodiment, users are granted a **Live-Peak** view—a short video snapshot (approximately 10 seconds) of a venue—available once per hour per account per venue. Access is managed by session tokens. In alternative embodiments, additional Live-Peak views may be purchased using virtual credits or in-app currency.

In one embodiment, the server stores for each venue a polygonal geofence defined by coordinate pairs. Each client device transmits GPS coordinates, Wi-Fi RTT, BLE beacon RSSI values, and/or NFC or QR tap data. A presence-verification module fuses these signals using a smoothing filter and hysteresis to reduce false entry/exit events. Upon satisfying a threshold, the server issues a cryptographically signed presence token to the client. The token includes a venue ID, a device ID hash, and an expiration time.

Each verified client receives an **ephemeral venue identifier** distinct from their persistent account ID. The identifier is rotated on a fixed interval or upon token renewal, preventing cross-venue tracking. The server uses the ephemeral venue identifier in lieu of a persistent ID for all in-venue interactions.

When a presence token expires or the device leaves the geofence, the server: invalidates the presence token and ephemeral venue identifier; terminates any active messaging channel; deletes or anonymizes undelivered messages and contact graph edges created during the session; and revokes any associated venue-payment tokens.

The system generates a cryptographically scoped **venue-payment token** linked to the presence token. The token expires automatically when presence ends. Payment authorization requests include the token, which the venue's point-of-sale system validates with the server before completing the transaction.

The system may provide a live view of venue media restricted to a viewing window (e.g., 10-20 seconds per session) with a cool-down interval before the next access, preventing continuous surveillance.

A venue may restrict token issuance to a whitelist of user IDs. The admin interface allows venue operators to draw or edit the geofence polygon, assign vibe classifications, and manage short-range beacons.

In one embodiment, the invention provides a computer-implemented system and method for confining user visibility and interaction to verified physical presence inside a venue. The system issues cryptographically signed presence tokens and ephemeral venue identifiers to verified client devices, enabling bounded interaction with co-present users. When a device exits the venue or the token expires, the server automatically terminates any messaging channel, deletes session data, and revokes venue-payment tokens. The system improves privacy, reduces unwanted follow-up, and enforces venue-scoped commerce.

FIG. 1 illustrates an exemplary system architecture for implementing geofenced social interactions within venues. The system architecture 100 includes: a user device 130 (e.g., smartphone) comprising a location sensor, microphone, and user interface; a venue geofence boundary 132; a server 134 comprising a processor and memory; a database 136 storing venue boundary data, user session data, and vibe profiles; a messaging gate 138 enforcing session-token authorization; a vibe profile generator 140; a venue environment including patrons, audio sources, and occupancy; a network (e.g., cellular, Wi-Fi); an application programming interface (API) configured for communication with user devices; a token issuance module; and a payment module integrated with a third-party provider.

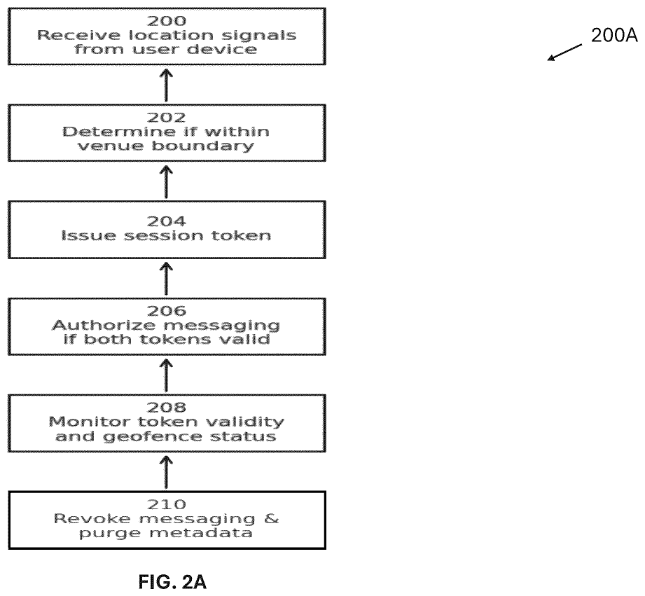

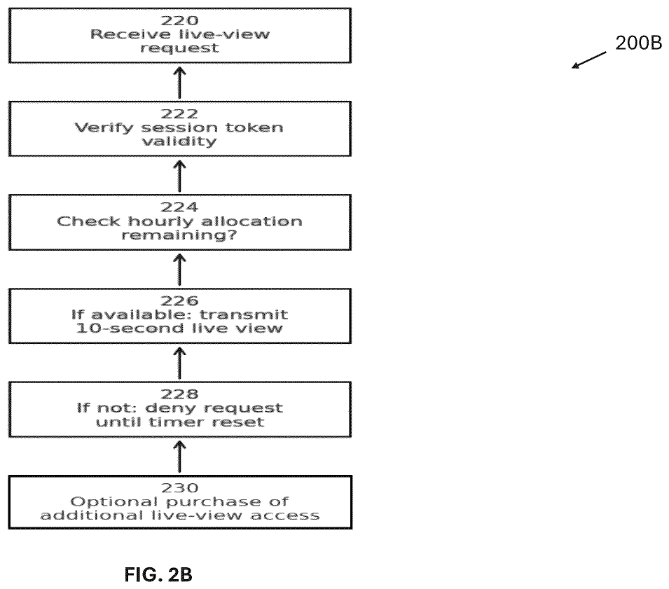

FIG. 2A illustrates a flowchart of operations for issuing venue-bound tokens and authorizing messaging. The operations 200A include the following steps:
200—Receive location signals from a user device.
202—Determine whether the user device is within a venue boundary.
204—If inside, issue a venue-bound session token with an expiration time.
206—Authorize messaging between a first user device and a second user device presenting valid tokens.
208—Monitor token validity and geofence status.
210—If a token expires or the user exits the venue, revoke messaging authorization and purge metadata.

FIG. 2B illustrates a flowchart of the **Live-Peak** feature providing limited venue live-view access. The Live-Peak feature 2B includes the following steps:
220—Receive a user request for venue live-view.
222—Verify session token validity.
224—Determine whether the hourly live-view allocation has elapsed.
226—If allocation is available, transmit the live-view stream for a defined time window (e.g., 10 seconds).
228—Deny additional requests until the timer resets.
230—Enable optional purchase of additional live-view access via in-app credits or payment.

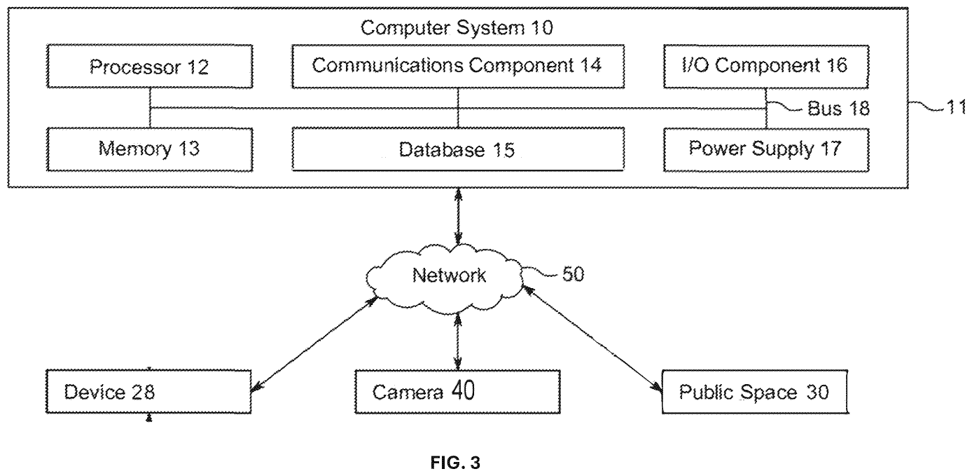

FIG. 3 illustrates a networked computer system comprising a server/database architecture 11 and a computer system 10. The computer system 10 includes a processor 12, memory 13, communications component 14, database 15, input/output component 16, power supply 17, and bus 18. The server/database architecture 11 is connected to a network 50. The network 50 is connected to a user device 28, a camera 40, and a public space 30.

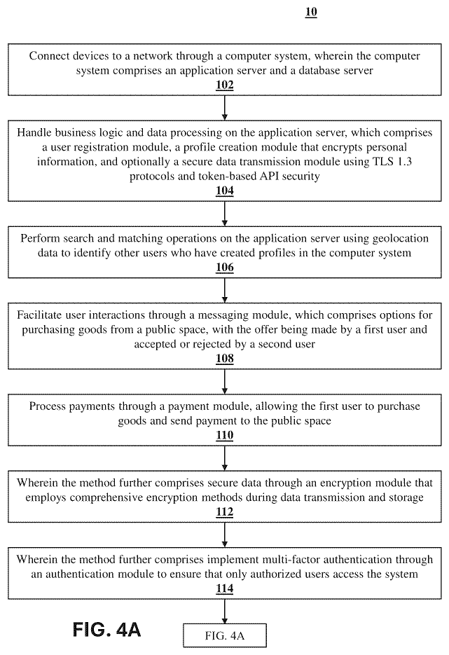

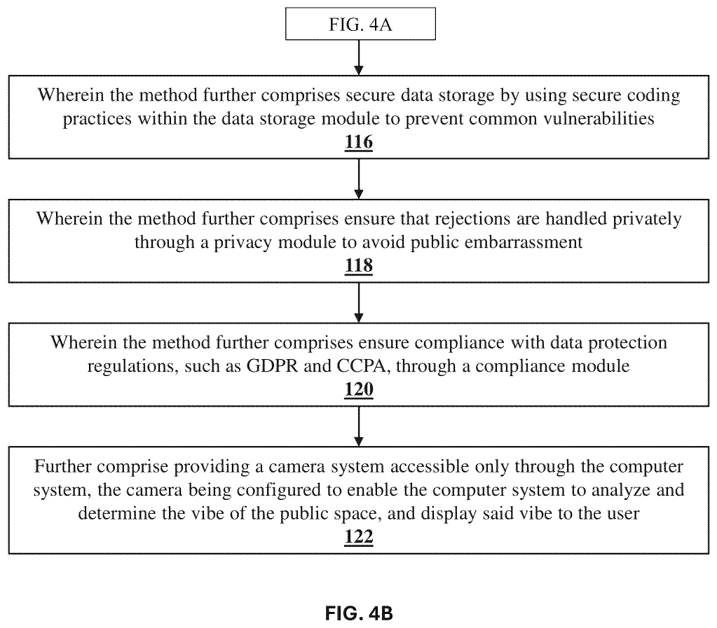

FIG. 4A illustrates a flowchart of a method 10 for enhancing human interactions, according to one or more embodiments. The networked computer system includes a computer system configured to connect to a network.

In a first step 102, the networked computer system includes devices capable of connecting to the network. The system further includes an application server and a database server connected to the network.

In a second step 104, the system handles business logic and data processing on the application server. The system includes a user registration module on the application server. The system also includes a profile creation module on the application server that encrypts personal information. The system further includes a secure data transmission module using TLS 1.3 protocols and token-based API security.

In a third step 106, a search and matching module performs searching and matching. The searching and matching can be performed using geolocation and/or geofencing data for other users who have created profiles in the computer system. The search and matching module on the application server processes data server-side.

In a fourth step 108, the system includes a messaging module for user interactions and offering to purchase goods from a public space, where one user makes the offer and the second user has the option to accept or reject the offer.

In a fifth step 110, the system includes a payment module for allowing the first user to purchase goods and send the payment to the venue.

In a sixth step 112, the networked computer system includes an encryption module for securing data. The encryption module employs comprehensive encryption methods to protect user data during transmission and storage.

In a seventh step 114, the system includes an authentication module. The authentication module implements multi-factor authentication to ensure only authorized users access the system by using two or more separate authentication processes.

FIG. 4B illustrates a flowchart of a method 10 for enhancing human interactions, according to one or more embodiments.

In an eighth step 116, the data storage is secured by encryption and an API layer. The data storage module prevents common vulnerabilities using secure coding practices.

In a ninth step 118, a privacy module ensures that rejections are handled privately to avoid public embarrassment.

In a tenth step 120, a compliance module ensures the system adheres to GDPR, CCPA, and other relevant data protection regulations.

In a twelfth step 122, a camera system is accessible only through the computer system. The camera system is configured to record video of the public space, which the computer system analyzes to determine the vibe and display said vibe to the user.

The networked computer system for enhancing human interaction through socializing (e.g., dating, friendship, group coordination, or professional networking) comprises several interconnected components designed to handle user data securely and facilitate interactions. The architecture includes the following components:

A communication network (e.g., the Internet) that facilitates data exchange between client devices and servers.

An application server that handles business logic, data processing, and communication between client devices and the database.

A database server that stores user data encrypted using strong encryption algorithms.

A security layer that implements various security measures, including encryption, authentication, and secure communication protocols.

The networked computer system operates over a standard Internet connection using secure protocols to ensure data privacy and integrity. The system comprises: devices (e.g., smartphones, tablets, and personal computers with Internet access); the Internet (a global system of interconnected computer networks that facilitates data exchange between client devices and servers); an application server hosted on a cloud service (e.g., AWS or Google Cloud) with high availability and redundancy to handle user requests and data processing; a database server hosted on a secure cloud service with encryption at rest and in transit to protect user data; and firewalls and IDS/IPS that monitor and control incoming and outgoing network traffic based on predetermined security rules and detect and prevent potential threats.

The computer system employs the following encryption methods:

Transport Layer Security (TLS) 1.3, which encrypts all data transmitted between client devices and the application server using a combination of symmetric and asymmetric encryption to prevent eavesdropping and tampering; Advanced Encryption Standard (AES)-256, which encrypts user data stored on the database server using a 256-bit key that is highly resistant to brute-force attacks; and a Key Management Service (KMS) that automates the creation, rotation, and destruction of cryptographic keys.

The computer system enables user registration and authentication via a user registration module and a multi-factor authentication (MFA) module. When a user initiates registration on a client device:

The device connects to the application server via the Internet.

The client application collects the user's email or phone number and password.

The password is hashed using crypt before transmission.

The server generates a unique verification code using a cryptographic random number generator (RNG) and sends it via TLS-encrypted SMTP or HTTPS.

The user enters the code to complete registration.

For login, the client device sends the crypt-hashed password; the server compares it to the stored hash. Successful login triggers MFA, requiring a fresh code sent to the registered contact method.

The computer system creates an encrypted user profile. Profile information (name, age, gender, location, preferences) is encrypted using AES-256 before storage on the database server. The encryption key is managed by the secure KMS. Each profile record includes a SHA-256 cryptographic hash to ensure data integrity during storage and retrieval.

The computer system provides secure data transmission via TLS 1.3 and token-based API security. All data transmitted between client devices and the application server is encrypted using TLS 1.3. Every API endpoint requires a valid JSON Web Token (JWT) that the server verifies before processing the request.

The computer system enables geofence-based search and matching. The system uses GPS and/or RFID to define a virtual geographic boundary (a “geofence”). When a mobile device enters or exits the geofence, the server can trigger actions including: (i) displaying profiles of other users that are presently inside the geofence; (ii) presenting venue-specific information; and (iii) removing or hiding profiles when the device leaves the geofence. Geofences may be dynamically generated or predefined polygonal sets of latitude/longitude coordinates.

Displaying profiles of other users inside the same geofence; showing venue-specific information; or removing profiles when the device leaves.

Geofences are either dynamically generated or predefined polygonal sets of latitude/longitude coordinates.

Search and matching occur server-side with encrypted results. Algorithms execute on the application server; user preferences and profiles are decrypted only in memory and never stored in plaintext. Match results are encrypted before transmission; only the intended recipient can decrypt them.

The computer system integrates with chat interface to embed the tone analysis engine using JavaScript (for web apps) or native code (for mobile apps), NLP Engine to use libraries like spaCy, NLTK, or transformer models from Hugging Face to implement the NLP capabilities, machine learning models to develop or use pre-trained machine learning models for sentiment analysis and tone detection. Backend support, if processing on the server, to ensure secure API endpoints for sending and receiving text data, processed using the NLP engine, and user feedback loop incorporates user feedback to improve the accuracy and relevance of the tone analysis over time.

An example system architecture is a computer system comprising the following components. User interface (e.g., a user-friendly interface for interaction), encryption module for comprehensive encryption methods to secure data. authentication module (e.g., multi-factor authentication to ensure authorized access), data storage module to secure data storage techniques to protect user information, messaging module allows users to message others and purchase drinks, privacy module ensures rejections are handled privately to avoid embarrassment, and compliance module ensures compliance with GDPR, CCPA, and other relevant regulations.

An example operation is the computer system configured to operate user registration and authentication (e.g., users register with the system using multi-factor authentication), user data is encrypted and stored securely, interaction and messaging (e.g., users can interact and message others at event venues, bars, restaurants), and users can purchase drinks for others through the application, handling rejections (if a user is rejected, the rejection is handled privately, reducing the risk of public embarrassment). Further, the system can allow the rejector to select whether or not the rejected user can contact them again through the system or vice versa.

Vibe check allows implementation of a camera system accessible only through the application to understand what the atmosphere is like at a public space, such as an event, restaurant, bar, or other space where people gather.

In some embodiments the methods described above may be carried out by a computing system such as a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. A storage machine may include memory devices such as various hard disk drives, CD, or DVD devices. On the other hand, a logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display with a graphical user interface (GUI) or other visual elements of the methods or processes described above. The display, storage machine, and logic machine may be integrated such that the above method may be executed while visual elements of the disclosed system and/or method are arranged on a display for the user. The computing system may include input peripherals for the system to receive user input. The input subsystem may be configured to connect to and receive input from devices such as a mouse, keyboard or gaming controller. A user can input a request for the computing system, such as requesting the computing system to display any of the above described information, or requesting that the user updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

The computer system can be structured to encourage positive in person interactions between users. The users can interact in person or face to face after beginning to build the relationship through the computer system, once they desire to do so.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

An example system architecture comprises the following components: a user interface (e.g., a user-friendly interface for interaction); an encryption module that implements comprehensive encryption methods to secure data; an authentication module (e.g., multi-factor authentication to ensure authorized access); a data storage module that uses secure data storage techniques to protect user information; a messaging module that allows users to message others and purchase drinks; a privacy module that ensures rejections are handled privately to avoid public embarrassment; and a compliance module that ensures compliance with GDPR, CCPA, and other relevant regulations.

An example operation includes: user registration and authentication (e.g., users register using multi-factor authentication); encrypted and secure storage of user data; interaction and messaging (e.g., users interact and message others at event venues, bars, or restaurants); purchasing drinks for others through the application; and private rejection handling (if a user is rejected, the rejection is handled privately, reducing the risk of public embarrassment).

Further, the system allows the rejector to select whether the rejected user can contact them again through the system, or vice versa.

Vibe check implements a camera system accessible only through the application to assess the atmosphere of a public space, such as an event, restaurant, bar, or other social gathering location.

In some embodiments, the methods described above are carried out by a computing system comprising a tangible computer-readable storage medium (also described herein as a storage machine) that holds machine-readable instructions executable by a logic machine (i.e., a processor or programmable control device) to provide, implement, perform, and/or enact the described methods, processes, and/or tasks. When such methods and processes are implemented, the state of the storage machine changes to hold different data. A storage machine includes memory devices such as hard disk drives, CDs, or DVDs. A logic machine executes machine-readable instructions via one or more physical information and/or logic processing devices. For example, the logic machine is configured to execute instructions to perform tasks for a computer program and may include one or more processors. The computing system includes a display with a graphical user interface (GUI) or other visual elements of the described methods or processes. The display, storage machine, and logic machine are integrated such that the method executes while visual elements of the disclosed system and/or method are arranged on the display for the user. The computing system includes input peripherals to receive user input from devices such as a mouse, keyboard, or gaming controller. A user inputs a request, such as displaying information or updating stored data for processing. A communication subsystem enables execution of the methods over a computer network, such as by communicating with a plurality of personal computing devices via wired and/or wireless communication devices. The described methods or processes are executed, provided, or implemented for a user or one or more computing devices via a computer-program product, such as an application programming interface (API).

The computer system is structured to encourage positive in-person interactions between users. Users may interact in person or face-to-face after beginning to build a relationship through the computer system, once they choose to do so.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

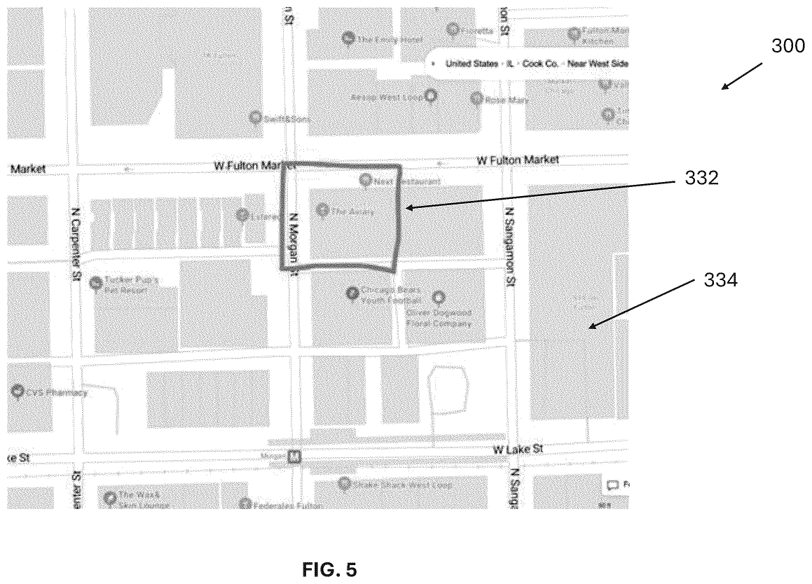

FIG. 5 presents a venue for a user. A user may draw a box around a venue 332. The venue 332 is drawn in a map 334 of the app. The venue 332 may include a sidewalk and/or street.

Other users (e.g., a second and/or a third user) of the app are allowed to request and receive direct messages from and to the first user if the other users are in the same venue 332 as the first user. Profiles of the other users are visible while the other users are within the boundaries of the venue 332 of the first user. Boundaries of the venue 332 are set manually within the admin portal or automatically using a third-party tool, such as a maps platform. Registered venues 332 can refine boundaries (e.g., four pairs of coordinates) around establishments to include additional area. In the admin portal or admin section of the app, the admin sets bound for the venue 332. The mobile app accesses device hardware (e.g., GPS and OS API) to access a user's precise location. The mobile app sends the precise location to the API. If a user's precise location is within the boundary of a registered venue 332, the API returns a list of users within the same boundaries of the venue 332. The mobile app displays a list of profiles of the other users that can interact with a first user.

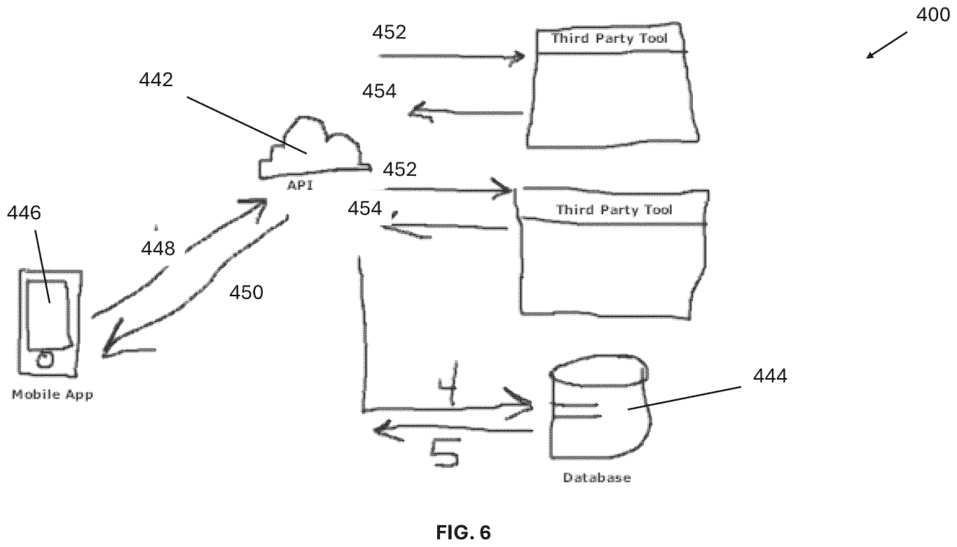

FIG. 6 presents a backend service application programming interface (API), according to one or more embodiments. The backend 400 provides centralized data access for user, profile, and venue data. The API 442 is connected to a database 444 to query data based on parameters received from requests from the mobile app 446. The backend 400 uses data in the database 444 to analyze venue boundaries and provide profile lists when a registered user submits a request with location coordinates received by the device hardware GPS. The database 444 holds all data necessary for the standard and extended operation of the mobile app 446 and administrator portal. The mobile app 446 sends a location of a user in a request 448 to query user lists. The API 442 receives the request 448 and sends relevant information 452 to third-party tools for processing. The third-party tools provide venue boundaries 454 based on a location of the user. Multiple requests 452 to third-party tools may be sent simultaneously to expedite the API response times. Data 454 from third-party tools is sent back to the API. Data 454 is processed and a database query is made to retrieve a list of users based on the venue boundaries. User profile data is retrieved from the database and processed. A response 450 is sent back to the mobile app 446 for the user.

The mobile application (app) 446 is a real-time social discovery and venue-vibe app that enables users to find local bars and venues based on the live atmosphere, crowd, and events occurring at each location. The app uses a combination of user-generated content, venue feeds, and geolocation to provide a dynamic snapshot of what is happening in real time. A standout feature is its geofenced, location-based communication functionality, which activates only when users are physically inside a participating venue, allowing the users to see and interact with others at that location. Profiles vanish once a user leaves, creating a frictionless, in-the-moment way to connect without long-term visibility.

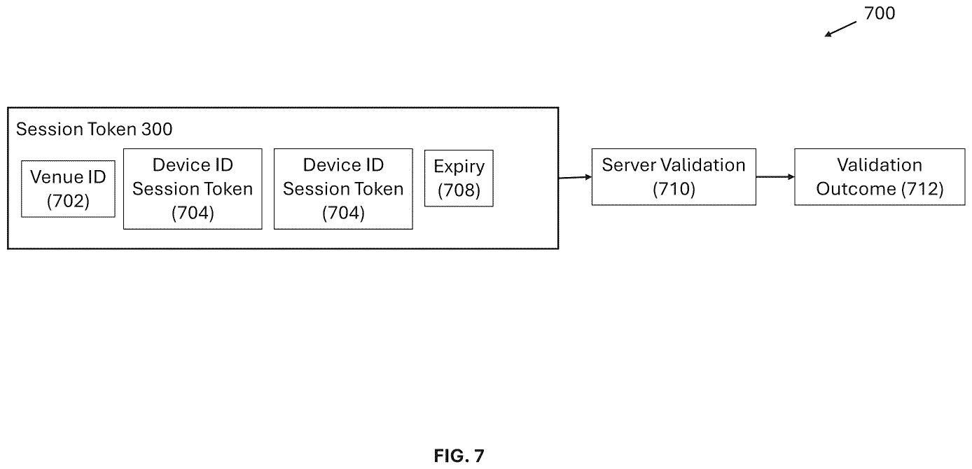

FIG. 7 illustrates the structure of a venue-bound session token and associated validation sequence. The structure 700 includes a session token 700, venue identifier 702, device identifier 704 (hashed), nonce value 706, expiration timestamp 708, server validation step 710 confirming signature and token freshness, and token validation outcome 712 authorizing or rejecting user actions.

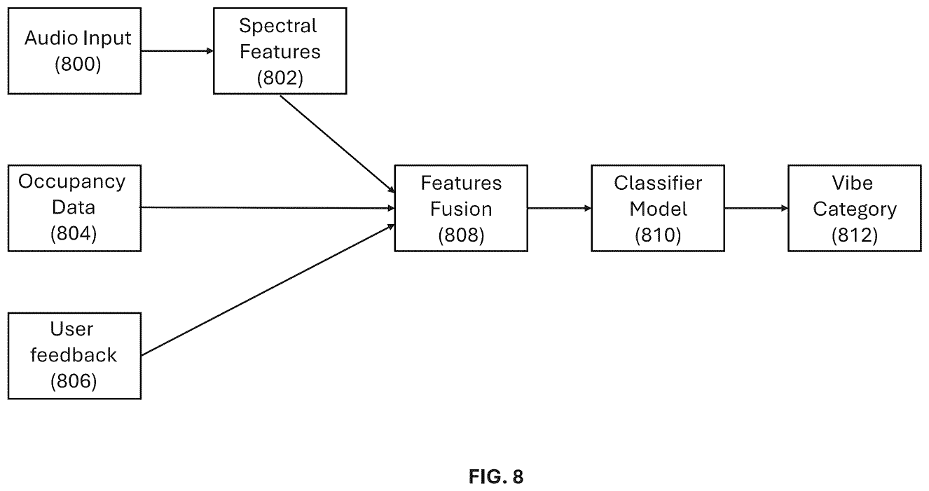

FIG. 8 illustrates a machine learning pipeline for computing venue vibe categories. The machine learning pipeline 800 includes an audio data input 800 from microphones, spectral feature extraction 802 (e.g., log-mel spectrogram), occupancy vector 804 derived from device counts or sensors, user feedback data 806, feature fusion module 808, classifier model 810 (e.g., convolutional neural network), vibe output category 812 (e.g., Popp'n, Buzzin, Chill'n), and transmitted vibe profile 814 stored in database and displayed on user device.

This feature is not exclusively for dating; rather, it is designed to support broader social interaction within shared physical environments. The system is intended to foster spontaneous, meaningful engagement between users in any type of venue. Whether it is a nightclub, gym, conference, or restaurant, the system leverages geolocation and geofencing to create a contextualized digital experience rooted in real-world presence.

When viewing or interacting with people in the same location, the app does not limit the interface to a single format. The layout and presentation of nearby users are dynamically adjusted based on app version, feature rollout, or user subscription status. Display methods include a scrolling menu, a prioritized or boosted display for premium users, a swipe-based interface, an accept/reject prompt, a randomized or one-at-a-time view (similar to Tinder or Bumble), or a multi-profile grid layout. This flexible interface structure ensures user experience adaptability and reinforces the core protection of the app's geolocation/geofence-triggered, venue-specific interaction system. Such versatility is key to securing comprehensive patent protection and preventing workarounds that mimic the real-time, presence-based interaction model.

A vibe detection system uses a machine learning-based engine (e.g., neural network) to classify a venue atmosphere using video, sound, and user input to improve the accuracy of “Popp'n,” “Buzzin,” or “Chill'n” designations. An augmented reality (AR) integration module allows users to visualize social density or venue features by overlaying digital data via their phone camera in AR mode. A cross-venue discovery mode supports limited visibility of users or vibe status in nearby or adjacent geofenced venues, enabling discovery across clusters of locations. A predictive venue trends module leverages past activity and event schedules to forecast future vibe levels, enabling smarter planning. A check-in hardware or NFC integration module supports physical check-in options using venue hardware, NFC tags, or QR codes to validate geofence presence. An advanced ad targeting and placement dynamic venue module delivers ads and time-sensitive promotions based on user engagement, dwell time, or interaction trends.

Current dating apps, disconnected from real-world presence and static venue platforms, offer no real-time insight for social planning based on outdated or irrelevant data. Current social and dating apps fail to bridge the gap between online interaction and real-world spontaneity. Users often experience misalignment between expectations and reality when choosing a venue, especially when seeking a specific vibe or social environment. Similarly, dating apps often lead to extended messaging chains without ever transitioning to real-life interaction. The app 446 solves these problems by letting users assess a venue's vibe in real time, not through outdated reviews or generic tags. The app encourages organic connections at the moment they are physically possible via its on-site-only interaction feature. The app enables venues to broadcast current events, DJs, specials, or crowd size, age groups, and gender to draw in patrons better aligned with their target demographic. The app merges social discovery, dating, and venue visibility into one seamless, vibe-first platform that works only in real time and on-location. For example, a user decides where to go by opening the app and comparing current vibes across venues—one vibe shows a live feed of a packed karaoke night, another highlights drink specials and a quiet crowd. The user picks the vibe based on the atmosphere they are after. Another example is a single user walking into a bar. Upon entering, the interaction feature activates. The user can see others in the bar who are also open to meeting someone. They send one thoughtful message to break the ice. A further example is a bar owner promoting a local DJ night. Through the venue feed, the bar uploads live clips and flyers in real time, increasing turnout from nearby users who discover the event via the app.

Furthermore, the app helps travelers in a new city find the most happening spot with the crowd they are looking for, without relying on outdated reviews (e.g., map reviews). The app emphasizes real-time venue insights and spontaneous in-person interactions. The app includes live venue feeds (not pre-scheduled or RSVP-based events), in-venue interaction activation that is available only during physical presence (no lingering messages, no virtual browsing), multi-environment flexibility (the app is designed to scale beyond nightlife to gyms, libraries, cafes, and events like conferences while preserving the core in-the-moment connection model), and a one-message contact system in interaction mode, which forces intentionality and avoids the fatigue of endless swiping or small talk. The app combines dynamic vibe-tracking, instant interaction, and geofenced social discovery into a single, in-the-moment user experience.

Users create a friend list or approved contact group within the app. Friends can see each other's active venue locations (when enabled) similar to a real-time social map. The app's location sharing is contextual to venue presence and operates only when the user has opted in and is within a geofenced zone. The app is not persistent and does not allow background tracking. Location visibility ends when the user leaves the venue or disables visibility. Each user maintains full control over who can view their location and may toggle visibility settings on a per-friend or global basis. Users may block or hide their venue location from specific friends without removing them from their contact list. The app is designed to enhance spontaneous meetups and improve social connection dynamics without compromising privacy or infringing on third-party patents.

A private event mode allows a venue or host to create a geofenced social experience limited to registered or invited users only. The app is used for private parties, corporate functions, or exclusive club nights, where the social layer of the app is restricted to known attendees. In venues lacking sufficient sensor input or user activity, operators manually assign a vibe status, such as Popp'n, Buzzin, or Chill'n, through the venue dashboard. This ensures accurate classification of the crowd atmosphere even in low-data scenarios. The displayed vibe takes various visual forms, such as a meter, heat wave effect, or other dynamic indicators. Geolocation and geofencing are established using mapping platforms. Alternatively, the perimeters of a venue are manually defined by the venue owner, event organizer, festival operator, or the developer. Upon entering a geofenced venue, users are prompted with a self-check-in option, allowing them to accept or reject visibility within the location. Automatic check-in also occurs when a user remains within a geofenced area or establishment for a specified amount of time. This feature is enabled by default but can be disabled by the user through their settings. Automatic check-out occurs when a user exits the geofenced perimeter, either immediately or after remaining outside the boundary for a designated duration. The perimeter is defined by a specific distance in feet to ensure accurate detection of entry and exit events.

A venue-controlled vibe override allows, in venues without sufficient sensor data or app density, operators to manually assign the vibe status (Popp'n, Buzzin, Chill'n) through the venue dashboard. The venue-controlled vibe override ensures meaningful classification even in low-data scenarios. A wearable-based check-in integrates future authentication options such as Bluetooth wristbands or QR-coded digital badges to confirm venue presence. The wearable-based check-in is suited for conferences, large festivals, or gyms where GPS accuracy may be unreliable indoors.

A session-based data purge automatically removes user profiles and communication logs from venue visibility once the geofence is exited. This prevents unauthorized follow-up or outside-the-venue interaction attempts. Anonymized venue analytics allow venue partners to receive metrics like engagement volume, feature usage, and peak hours without exposing personally identifiable user data. Toxicity and abuse moderation use an NLP engine to flag harmful or aggressive language in messages. Rejected or flagged users are automatically filtered from view and cannot re-engage without venue/user reauthorization. User reports trigger backend moderation and optional suspension protocols.

A live view protocol (e.g., time-based view control) allows users to access a venue's live feed. Users view a brief video or snapshot for durations of approximately 10 to 20 seconds per session. The system enforces a time-based lockout, preventing users from viewing the same live feed again until a minimum of one hour has elapsed.

As used herein: “venue” means a physical space defined by one or more latitude/longitude coordinate pairs forming a geofence polygon; “presence verification” means determining, using location telemetry and optional short-range signals, that a mobile client device is physically within a venue; “presence token” means a cryptographically signed, short-lived token issued to a verified client device, scoped to a venue; “ephemeral venue identifier” means a transient identifier assigned to a verified user, rotated periodically and invalidated when presence ends; “venue-payment token” means a token scoped to a venue and presence token that permits payment for goods or services while present; and “bounded interaction” means a messaging channel constrained to a single message or a limited thread until the recipient elevates the session.

What is claimed is:

1. A computer-implemented system, comprising:
(a) a user device including at least one location sensor;
(b) a server including at least one processor, a memory, and an application programming interface (API) coupled to a network; and
(c) a database storing venue boundary data including coordinate polygons;
wherein the server is configured to:
(i) receive, from the user device, location signals;
(ii) determine, using the location signals and the venue boundary data, that the user device is within a venue geofence;
(iii) issue to the user device a venue-bound session token including a venue identifier, a nonce, and an expiration time;
(iv) generate a venue vibe profile by fusing (A) audio features extracted from at least one microphone, (B) occupancy estimates derived from device counts or venue sensors, and (C) explicit user feedback, and transmit the venue vibe profile to the user device; and
(v) operate a messaging gate that authorizes delivery of messages only while both a first user device and a second user device present valid venue-bound session tokens, and that, when either device exits the geofence or a token expires, automatically (1) revokes authorization, (2) purges venue-scoped message metadata, (3) invalidates any ephemeral venue identifier, and (4) revokes any associated venue-payment token.

2. The system of claim 1, wherein the server updates parameters of a classifier used to generate the venue vibe profile based on labeled interaction outcomes and explicit user feedback logs, thereby adapting the venue vibe profile over time.

3. The system of claim 1, wherein the user device is further configured to present a notification when a venue vibe profile satisfies user-specified preferences derived from the user's prior interaction history.

4. The system of claim 1, further comprising a payment interface coupled to a third-party payment service provider, the payment interface being configured to enable a first user to pay a venue merchant for goods or services for a second user while both users'venue-bound session tokens remain valid.

5. The system of claim 1, wherein the server restricts venue live-view access to no more than ten seconds per user per venue per hour as tracked by the venue-bound session token, and enables additional live-view access upon purchase of in-app credits.

6. The system of claim 1, wherein venue boundaries are editable in an administrator portal that accepts rectangular or polygonal coordinates to override automatically detected boundaries.

7. The system of claim 1, wherein the first user device and the second user device engage in a controlled social interaction session comprising:
(a) transmitting, from the first user device, an initial message or offer;
(b) determining, at the server, whether the second user device accepts or rejects the initial message or offer;
(c) when the offer is accepted, enabling follow-up communication while both venue-bound session tokens remain valid; and
(d) when the offer is rejected, terminating the interaction and rendering the first and second users mutually hidden from further communication for a defined cool-down period;
wherein the controlled social interaction is not limited to dating and includes at least one of friendship, group coordination, or professional networking.

8. The system of claim 1, wherein geofence validation further requires at least one of: a near-field communication exchange, a QR code scan, or a Wi-Fi or Bluetooth Low Energy signal-based presence check.

9. The system of claim 1, wherein upon expiration of a venue-bound session token the server deletes venue-scoped identifiers and message metadata and retains only anonymized aggregate analytics.

10. The system of claim 1, wherein acceptance of the initial message or offer triggers generation of a tokenized payment intent that is routed to a venue merchant account through the third-party payment service provider.

11. The system of claim 1, further comprising access to at least one venue camera through the API, wherein the server extracts image or video features from camera data as additional inputs to the venue vibe profile and transmits the venue vibe profile to the user device.

12. The system of claim 1, wherein communications and venue-bound session tokens are encrypted in transit using a transport-layer security protocol and encrypted at rest in the database using a symmetric block cipher.

13. A computer-implemented method, comprising:
(a) receiving, at a server, location signals from a user device;
(b) determining, using venue boundary data stored in a database, that the user device is within a venue geofence;
(c) issuing, to the user device, a venue-bound session token;
(d) computing a venue vibe profile by:
(i) extracting audio intensity features from at least one microphone,
(ii) estimating occupancy from device counts or venue sensors, and
(iii) integrating explicit user feedback;
(e) applying a classifier to map fused features from steps (d)(i)-(iii) to a discrete vibe category; and
(f) enabling message delivery between the user device and a second user device only while both devices present valid venue-bound session tokens.

14. The method of claim 13, further comprising updating parameters of the classifier based on labeled interaction outcomes and explicit user feedback logs.

15. The method of claim 13, further comprising presenting, at the user device, a notification when a venue vibe profile satisfies user-specified preferences derived from the user's prior interaction history.

16. The method of claim 13, further comprising enabling, through a payment interface, a first user to pay a venue merchant for goods or services for a second user while both users'venue-bound session tokens remain valid.

17. A non-transitory computer-readable medium storing instructions that, when executed by one or more processors, cause the processors to perform operations comprising:
(a) receiving location signals from a user device;
(b) determining, using venue boundary data, that the user device is within a venue geofence;
(c) issuing a venue-bound session token to the user device;
(d) computing a venue vibe profile by extracting audio intensity features, estimating occupancy from device counts or venue sensors, and integrating explicit user feedback;
(e) applying a classifier to map fused features to a discrete vibe category; and
(f) enabling message delivery between the user device and a second user device only while both devices present valid venue-bound session tokens.

18. The non-transitory computer-readable medium of claim 17, wherein the instructions further cause the processors to update parameters of the classifier based on labeled interaction outcomes and explicit user feedback logs.

19. The non-transitory computer-readable medium of claim 17, wherein the instructions further cause the processors to restrict venue live-view access to no more than ten seconds per user per venue per hour as tracked by the venue-bound session token, and to enable additional live-view access upon purchase of in-app credits.

20. The non-transitory computer-readable medium of claim 17, wherein the instructions further cause the processors to delete venue-scoped identifiers and message metadata upon expiration of the venue-bound session token and to retain only anonymized aggregate analytics.

21. The system of claim 1, wherein the server requires multi-factor authentication of a user identity prior to issuing the venue-bound session token.

22. The system of claim 1, wherein the server stores authentication credentials as salted password hashes and enforces role-based access controls on administrative actions including geofence edits and analytics export.

23. The system of claim 1, wherein the venue vibe profile is generated by a pipeline that further includes smoothing of occupancy estimates over a sliding time window and hysteresis thresholds to reduce boundary-crossing oscillation near a geofence edge.
